(19) United States
(12) Patent Application Publication
(10) Pub. No.: US 2016/0251892 A1
(43) Pub. Date: Sep. 1, 2016

(54) Horizontal Reinforcement Bar

(71) Applicant: Edward L. Nofziger, Archbold, OH (US)

(72) Inventor: Edward L. Nofziger, Archbold, OH (US)

(21) Appl. No.: 15/150,817

(22) Filed: May 10, 2016

Related U.S. Application Data
(63) Continuation of application No. 13/899,966, filed on May 22, 2013.

(51) Int. Cl. E06B 3/48

(52) U.S. Cl. CPC E06B 3/488

(57) ABSTRACT

A horizontal reinforcement bar for new and existing sectional garage doors. The horizontal reinforcement bar will increase the wind load resistance of the sectional garage door. The horizontal reinforcement bar is C-shaped and requires no support brackets for fastening. The reinforcement bars are further strengthened by the addition of a reinforcement plate adding to the wind load resistance of the sectional garage door.

### TECHNICAL BACKGROUND

The present invention pertains to a wind load reinforcement beam for a sectional garage door and a method of installing the reinforcement beams.

### BACKGROUND OF THE INVENTION

Sectional garage doors are typically made of lightweight materials. When the sectional garage doors close they must be able to withstand pressure forces, both inwardly and outwardly, due to atmospheric pressure. Sectional garage doors must be able to withstand wind loads in a variety of different applications. Reinforcement bars are frequently installed on new and existing sectional garage doors to increase their wind load resistance.

There have been attempts in the past to increase wind resistant by manufacturing horizontal reinforcement bars as in U.S. Pat. No. 6,408,926. The horizontal bars must be of suitable weight and strength to be effective. Further, single user installation is preferable. The existing prior art often requires additional personnel to hold the beam and attach the additional fasteners to the sectional garage door. The known prior art reinforcement bars, such as that shown in the '926 patent, require brackets or hinge straps to secure them in place. These additional brackets and hinge straps require additional fasteners and man hours for installation.

Accordingly, there is a need to provide a light weight horizontal reinforcement bar for sectional garage doors and a method for installing the same.

### SUMMARY OF THE INVENTION

The present invention provides an improved horizontal reinforcement bar for a sectional garage door, increasing wind resistance.

The present invention also provides an improved method for installing horizontal reinforcement bars on a sectional garage door and the like.

It is the principle objective of the invention to provide a sectional garage door with a specifically shaped horizontal strut, and a method of reinforcing a sectional garage door by attaching a series of horizontal reinforcement bars to the interior of a sectional garage door.

It is another objective of the invention to provide a horizontal reinforcement bar which can be installed by a single user in a timely manner.

It is another object of the invention to provide a horizontal reinforcement strut having a cross section shaped C channel with reinforcement plates positioned across the C channel at varying intervals along the horizontal reinforcement bar.

It is yet another object of the invention to provide a horizontal reinforcement bar which protects against positive and negative wind pressure.

It is another object of the invention to provide a horizontal reinforcement bar requiring no external fasteners, brackets or hinge straps.

### IN THE DRAWINGS

FIG. 1 is a top down view of the horizontal reinforcement bar.

FIG. 2 is a side view of FIG. 1.

FIG. 3 is an end view of FIG. 1.

FIG. 4 is a perspective view of one embodiment of the horizontal reinforcement bar attached to a garage door.

FIG. 5 is a perspective view of the horizontal reinforcement bar attached to a garage door.

### DETAILED DESCRIPTION OF THE INVENTION

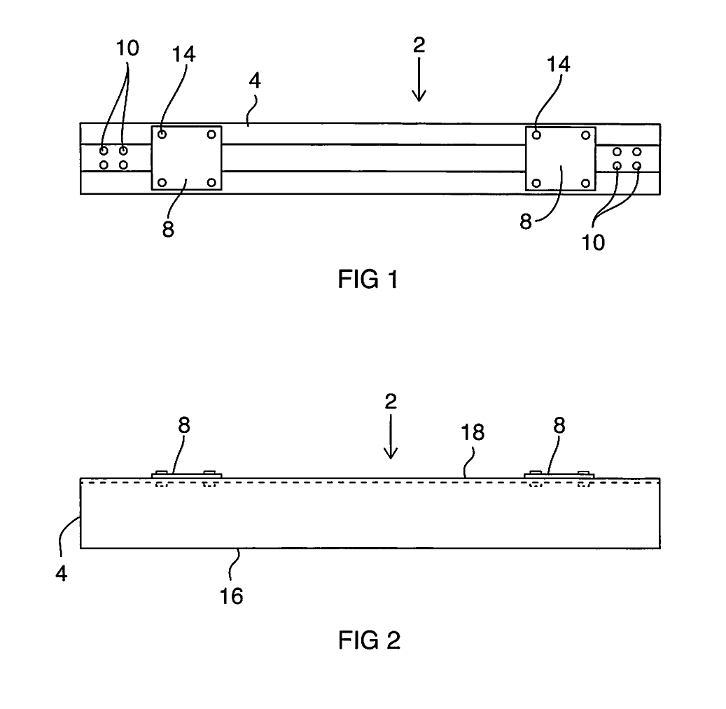

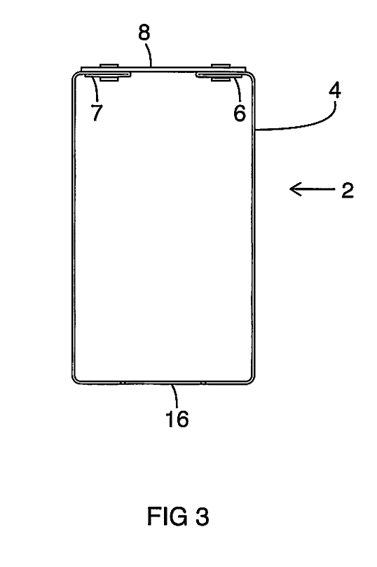

Referring now to FIGS. 1, 2 and 3 a horizontal reinforcement bar 2 is shown. The horizontal reinforcement bar 2 consists of a C-shaped frame 4, at least one reinforcement plate 8 and at least two fastening holes 10. The C-shaped frame 4 of the horizontal reinforcement bar 2 is further reinforced by folding in an edge 6 and an edge 7. At least one reinforcement plate 8 is added to a top portion 18 of the C-shaped frame 4 and is secured to the frame by a suitable fastener including but not limited to welding, bolt, screw, or glue. In the preferred embodiment the reinforcement plate 8 is secured to the frame 4 with four clinch locks 14.

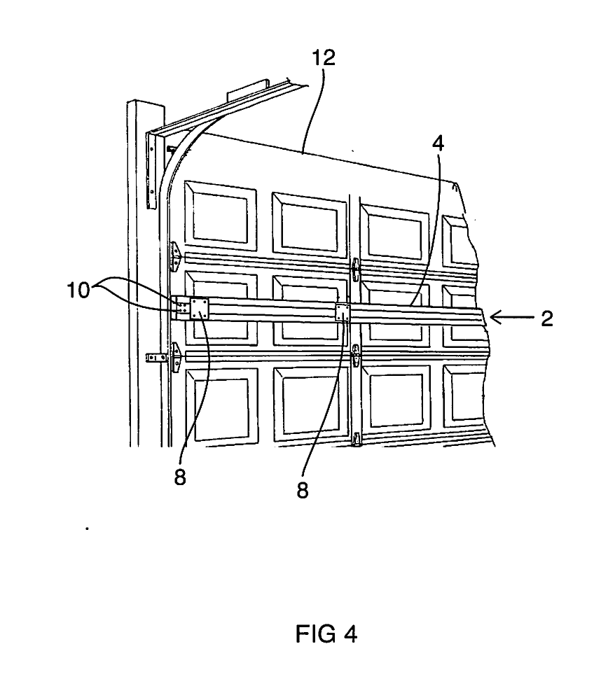

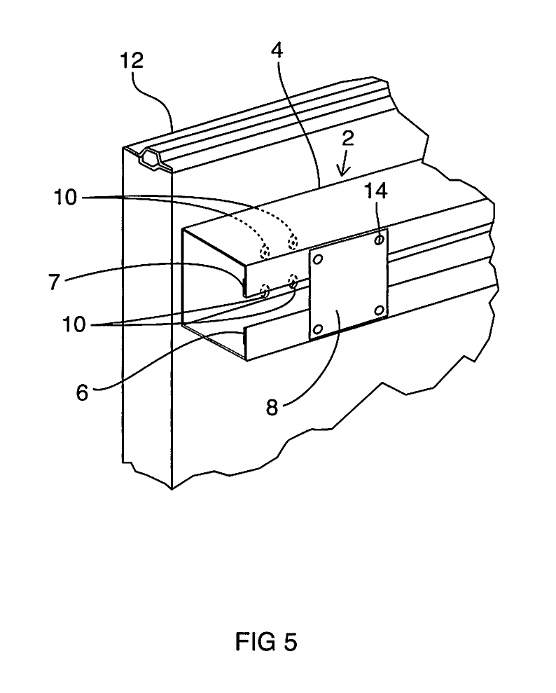

Referring now to FIGS. 4, 5 and 6, the horizontal reinforcement bar 2 is shown installed on a sectional garage door 12. A bottom portion 16 of the C-shaped frame 4 is secured to the sectional garage door 12 with at least two fasteners placed in fastener holes 10. In the preferred embodiment the horizontal reinforcement bar 2 is fastened to the garage door with a screw however any fastening method could be used including but not limited to welding, bolting or gluing the horizontal reinforcement bar 2 to the sectional garage door 12.

The fastener holes 10 are located in the bottom portion 16 of the C-shaped frame 4. The location of the fastening holes 10 provides adequate fastening while allowing faster installation by reducing the number of fasteners which must be installed. Prior art reinforcement bars require a screw above and a screw below the bar for proper installation. Installation of such prior art bars requires twice the number of fasteners of the present invention, often requiring multiple fasteners on the bracket and hinge strap along with installation fasteners on the horizontal reinforcement bar. The horizontal reinforcement bar 2 of this invention requires a lesser number of fasteners, thus allowing for faster and easier installation requiring less manpower without sacrificing reinforcement. The horizontal reinforcement bar 2 significantly reduces the number of fasteners by eliminating the need for the prior art reinforcement brackets and hinge straps, thereby, allowing for faster and easier installation, requiring less man power, without sacrificing reinforcement strength.

Reinforcement plate 8 is positioned on the top portion 18 of the c-shaped frame 4 sufficiently away from fastener hole 10 to allow for proper installation. In the preferred embodiment the reinforcement plate 8 is positioned sufficiently away from an edge to allow access to the fastening holes 10 for easier installation. The number of reinforcement plates 8 and fastener holes 10 will be determined by the length of the sectional garage door 12 and the horizontal reinforcement bar 2.

The horizontal reinforcement bar 2 is preferably constructed with a 4 inch or 6 inch sidewall. Other embodiments could include a 2 inch sidewall, a 3 inch sidewall, an 8 inch sidewall, a 10 inch sidewall, or a 12 inch sidewall. The bottom portion 16 of the horizontal reinforcement bar 2 must be of sufficient width to allow for the fastener holes 10. The C-shaped frame 4 and the reinforcement plate 8 are preferably fashioned from sheet metal such as steel or aluminum, however, any material could be used which can achieve the desired reinforcement.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

I claim:

1. An apparatus for reinforcing a sectional garage door comprising:
a C-shaped frame having a top portion and a bottom portion along with an open channel on the top portion;
at least two fastening holes;
at least one reinforcement plate;
at least one edge folded over onto itself on the top portion of the C-shaped frame

[symbol]

2. The apparatus of claim 1 further including a second edge of the top portion of the C-shaped frame is folded onto itself.

3. The apparatus of claim 1 wherein the reinforcement plate is fastened to the top portion of the C-shaped frame at the at least one folded edge.

4. The apparatus of claim 1 wherein the bottom portion of the C-shaped frame is secured to a rear face of the sectional garage door by a plurality of fasteners extending through the at least two fastening holes.

5. The apparatus of claim 1 further including at least four fastening holes.

6. A method for reinforcing a sectional garage door comprising:
placing a bottom portion of a horizontal reinforcement bar against the sectional garage door;
leveling the horizontal reinforcement bar;
fastening the horizontal reinforcement bar to the sectional garage door; [symbol]
